(19) United States
(12) Patent Application Publication
(10) Pub. No.: US 2015/0256431 A1
(43) Pub. Date: Sep. 10, 2015

(54) Selective flow inspection based on endpoint behavior and random sampling

(71) Applicant: Cisco Technology, Inc., San Jose, CA (US)

(72) Inventors: Kevin A. Buchanan, San Francisco, CA (US); Andrew E. Ossipov, Richardson, TX (US)

(73) Assignee: Cisco Technology, Inc., San Jose, CA (US)

(21) Appl. No.: 14/200,669

(22) Filed: Mar. 7, 2014

(51) Int. Cl. H04L 12/26; H04L 29/08

(52) U.S. Cl. CPC H04L 43/0876; H04L 67/10

(57) ABSTRACT

Presented herein are techniques for determining an initiator of network traffic, collecting at each of multiple instants of time, usage data for network traffic associated with the initiator, and storing historical usage data based on updates from usage data for the network traffic over time. Current usage data are compared to historical usage data of the initiator to determine whether current usage data are within an expected distribution with respect to the historical usage data. Based upon the comparison between the current usage data and the historical usage data, an inspection threshold is selected for traffic flows from the initiator, and a proportion of traffic flows associated with the initiator is determined to be inspected based on the inspection threshold.

### TECHNICAL FIELD

The present disclosure relates to detection and prevention of unauthorized access to a network by selective inspection of traffic flows.

### BACKGROUND

Modern enterprise networks rely on multiple layers of security devices, such as firewalls and Intrusion Prevention Systems (IPSs), for protection from external and internal threats. A typical firewall or IPS device maintains a stateful table of transit connection states and applies various security checks across one or more layers of the protocol stack to each incoming packet. As network bandwidth requirements continue to increase, security devices such as firewalls and IPSs frequently become performance bottlenecks, particularly as advanced packet inspection tasks consume much more processing power than simple traffic forwarding by switches and routers. Even though the vast majority of protected traffic does not pose a security threat, each packet from every source is inspected at the same level unless the administrator statically defines the trusted classes of traffic and/or selectively disables application inspection. However, neither approach is ideal, as implicitly trusted application flows or endpoints may become compromised and present a security risk, while inspection of each packet may impact network performance.

### BRIEF DESCRIPTION OF THE DRAWINGS

FIG. 1 is a block diagram of a network system in which the techniques disclosed herein may be employed.

FIG. 2 is a block diagram of functional components according to the techniques disclosed herein.

FIG. 3 is a more specific example of a flowchart showing creation of database records according to the techniques described herein.

FIGS. 4A-4D are more specific examples of flowcharts for selection of a threshold and sampling of a traffic flow according to the techniques described herein.

FIG. 5 is an illustration of types of information stored in a database record according to the techniques described herein.

FIG. 6 is a flowchart showing updates of historical usage data records according to the techniques described herein.

FIG. 7 is an example flowchart generally describing the techniques described herein.

FIG. 8 is an example of an apparatus configured to selectively inspect traffic flows according to the techniques disclosed herein.

### DESCRIPTION OF EXAMPLE EMBODIMENTS

### Overview

Presented herein are techniques for determining an initiator of network traffic, collecting at each of multiple instants of time, usage data for network traffic associated with the initiator, and storing historical usage data based on updates from usage data for the network traffic over time. Current usage data are compared to historical usage data of the initiator to determine whether current usage data are within an expected distribution with respect to the historical usage data. Based upon the comparison between the current usage data and the historical usage data, an inspection threshold is selected for traffic flows from the initiator, and a proportion of traffic flows associated with the initiator is determined to be inspected based on the inspection threshold.

### Example Embodiments

Techniques are presented herein for an advanced behavioral model that allows selective levels of inspection to be applied to different categories of traffic flows. These techniques may be used in conjunction with various security devices, including firewalls, IPSs, spam/malware/antivirus scanners, etc., to offer a level of protection based upon historical information. In general, the techniques disclosed herein build and maintain a historical database of per-initiator application usage data/patterns, that is, the usage data/patterns for an application associated with a traffic flow from a particular initiator, and selectively subject new and existing transit connections/traffic flows to stateful and/or application inspection, as well as network and transport-level protocol inspection, based on deviations from known historical data and predefined thresholds. For example, “application” usage may be determined based on monitoring traffic flows for connections using Transmission Control Protocol (TCP) or User Datagram Protocol (UDP) destination ports. Additionally, traffic flows may be selectively inspected at various levels of the Open System Interconnection (OSI) model, including Internet Protocol (IP)/TCP/UDP levels or higher. This approach allows reducing the overall system load, traffic forwarding delays, and critical resource consumption while still providing a strong deterrent against malicious activity.

Techniques currently used for controlling access to a local area network include, for example, Adaptive Security Appliance (ASA), TCP State Bypass and IPS anomaly detection. ASA TCP State Bypass allows disabling various types of stateful inspection on transit TCP flows, but is performed statically, and is not compatible with application inspection. IPS Anomaly Detection builds a network traffic baseline relating to various metrics associated with incomplete TCP or UDP connections (or attempted destinations per initiator) and monitors subsequent traffic levels against established baselines. Both approaches lack the ability to apply selective levels of in-depth inspection to suspect flows, as described herein, and techniques such as IPS anomaly detection measure all transit traffic against the same set of thresholds.

The proposed techniques disclosed herein allow selective inspection, based on a predefined sampling/inspection threshold, of traffic flows for each application associated with a particular initiator, and dynamically apply varying levels of security inspection to traffic flows based upon historical usage data. In general, the techniques presented herein ensure that a determined number of flows from every initiator for each associated application will be inspected according to a sampling threshold. The presented approach builds a trust model (reputation) for each initiator and associated application to determine how frequently and deeply additional checks will be performed to confirm a previously established trust level.

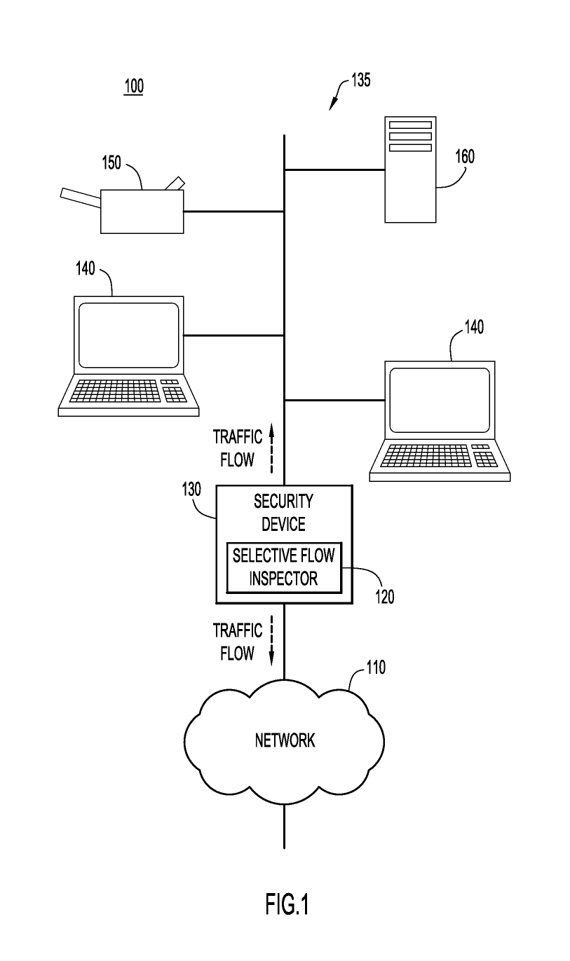

FIG. 1 is a block diagram of a network traffic inspection system 100 including a network 110, a selective flow inspector 120, a security device 130 and various other devices as part of a local area network (LAN) 135, including computer terminals 140, a printer 150 and a server 160. Traffic is shown flowing bidirectionally from LAN 135 to network 110 and from network 110 to LAN 135. Security device 130 may be any type of device used for network traffic inspection such as a firewall, IPS, etc., and may function in conjunction with selective flow inspector 120.

Both incoming traffic from network 110 and outgoing traffic to network 110 pass through security device 130 and selective traffic inspector 120. Selective traffic inspector 120 offers protection to both incoming and outgoing traffic, as both types of traffic flows are subject to selective inspection. As explained in additional detail below, selective flow inspector 120 builds and maintains a database of all known initiators of traffic flows and corresponding applications, thus creating an association between each application and initiator. By continuing to track usage data/patterns of each per-initiator application, deviations from past behavior may be identified.

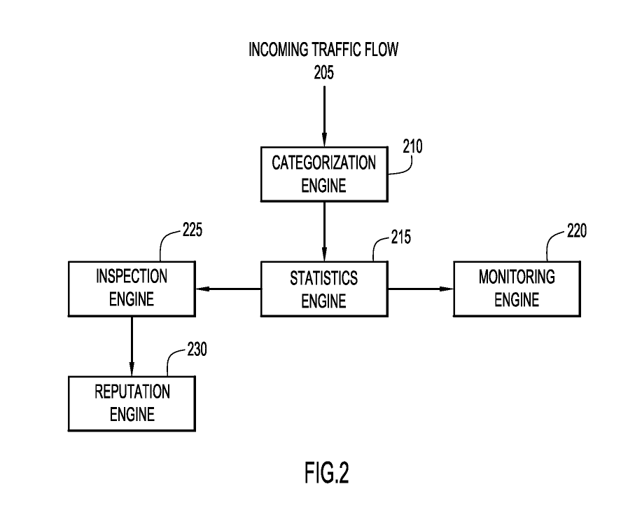

FIG. 2 provides an example of a high level functional block diagram of a selective flow inspector. Incoming traffic flow 205 is categorized into a trusted, untrusted or malicious category by categorization engine 210. Based upon this categorization, a sampling threshold is applied (or, in the case of malicious activities, the flow may be dropped), and the traffic flow is sent to statistics engine 215, where it is either selected for inspection or not selected for inspection and monitored for deviations from expected behavior (via historical usage data) by monitoring engine 220. For traffic flows that are subject to inspection, such flows are sent to an inspection engine 225 and results of the inspection are used to help establish a reputation of the initiator/endpoint of the traffic flow via reputation engine 230. This process is described in additional detail below. Each of the functional blocks shown in FIG. 2 may be implemented in software or hardware.

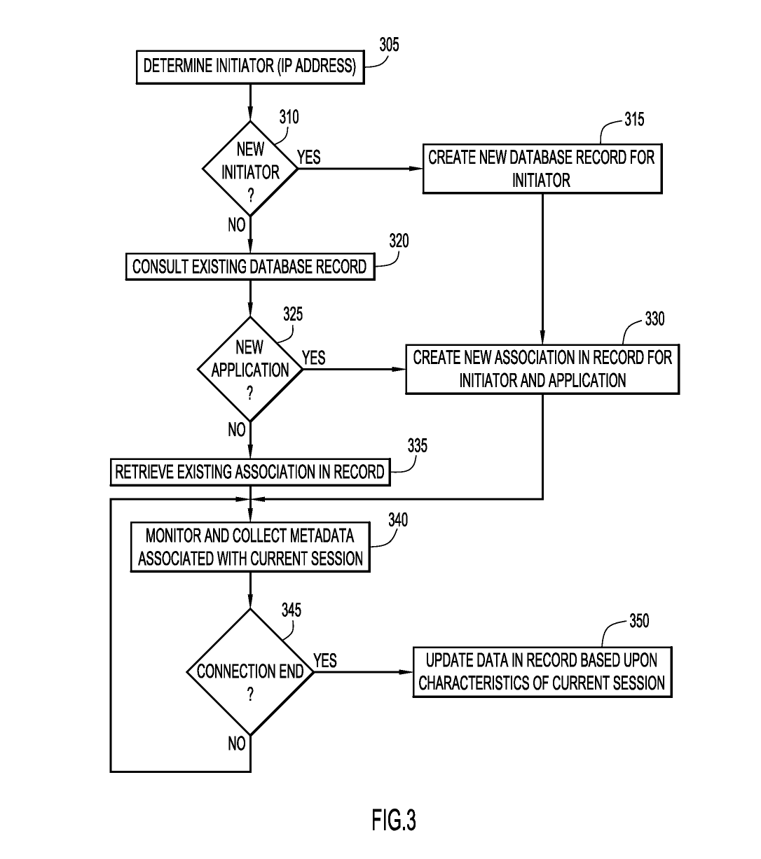

FIG. 3 shows an example flowchart showing database record creation, by selective flow inspector 120, of per-initiator application associations and corresponding current usage data. At operation 305, for each initiator of a traffic flow, an identity of the initiator is determined using information contained in network traffic from the initiator, such as a source IP address, etc. At operation 310, the identity of the initiator is checked against a database to determine if the initiator is new. If the initiator is new, a corresponding record containing historical usage information does not yet exist in the database and is therefore created at operation 315. If a new record is created, this record is populated with information associating the initiator with an application at operation 330. Alternatively, if the initiator is not new, an existing database record has already been created and is accessed at operation 320.

At operation 325, for a known initiator, the selective flow inspector determines if the per-initiator application association exists within the database record. If the initiator has not previously used a particular application, a new association is created between the application and the initiator, as shown in operation 330. Otherwise, an association exists, and is retrieved at operation 335 for subsequent modification.

Applications such as Domain Name Service (DNS), File Transfer Protocol (FTP), Hypertext Transport Protocol (HTTP), etc., are generally associated with a specific destination port and protocol. For example, DNS is generally associated with port 53 and UDP, FTP is generally associated with port 21 and TCP, HTTP is generally associated with port 80 and TCP, etc. Based upon database records associating a particular application (via destination port and protocol) with an initiator, the selective flow inspector is able to determine whether a particular application from a given initiator has been previously used. In order to obtain such information, the selective flow inspector may interface with an application inspection engine, e.g., inspection engine 225, of a security device to obtain port and protocol information. Traffic may also be inspected at an IP/TCP/UDP level. Accordingly, a number of applications (and therefore, application associations) stored in a database record may be determined by the quantity of unique applications (service ports) that the endpoint is accessing, and may be capped by a static setting that limits the number to a quantity of most recent entries in order to preserve system resources. In other embodiments, the number of applications may be determined by the number of particular applications supported by the application inspection engine.

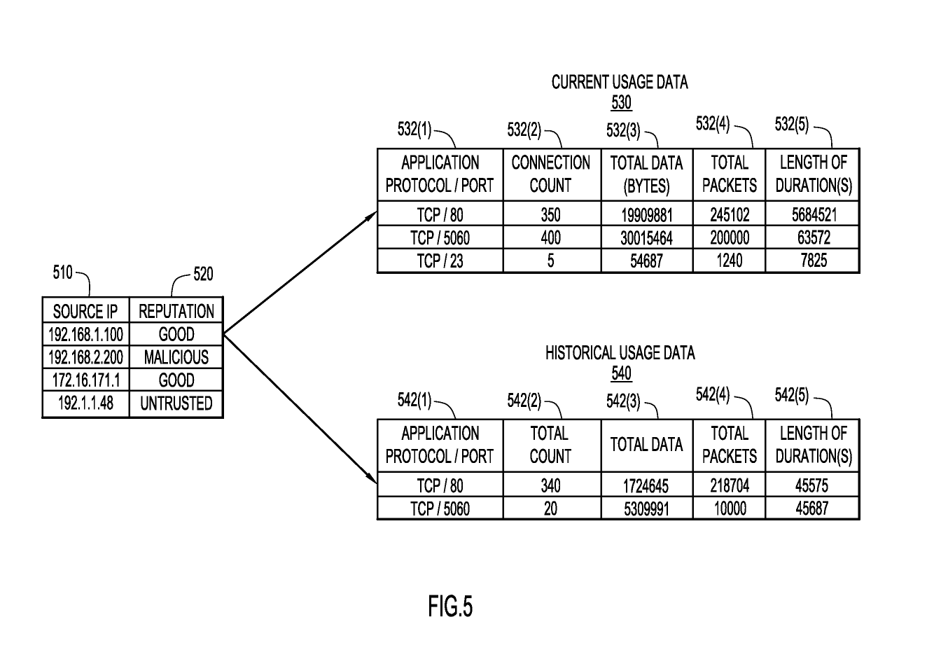

At operation 340, the current session is monitored and usage data (including metadata) is collected throughout the duration of the session. Collected usage data provides information regarding initiator/endpoint behavior and may include data associated with a per-initiator application connection, such as application port, protocol, connection count, total amount of data, total number of packets, duration of connection, etc. At operation 345, the current connection is monitored to determine termination of the session, and when the session terminates, the collected data is incorporated into the current usage data at operation 350, e.g., as described below in conjunction with FIG. 5.

The techniques disclosed above in conjunction with FIG. 3, may be repeatedly applied to create an association for each application from a given initiator, as described herein.

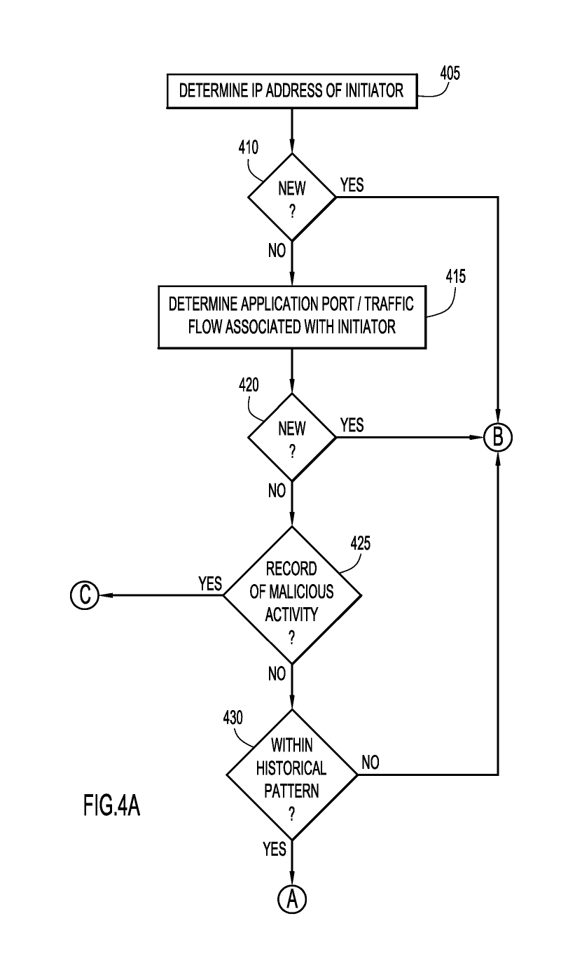

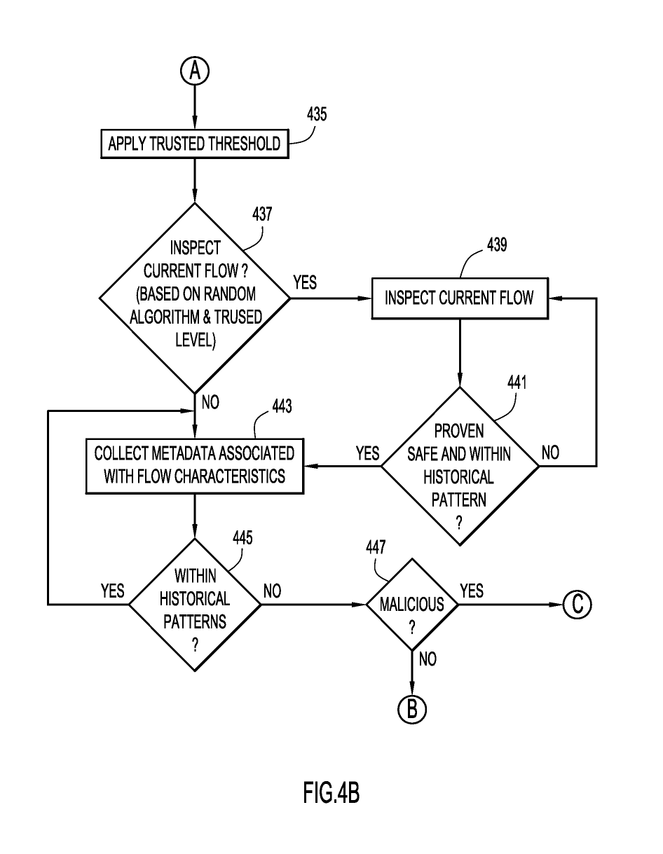

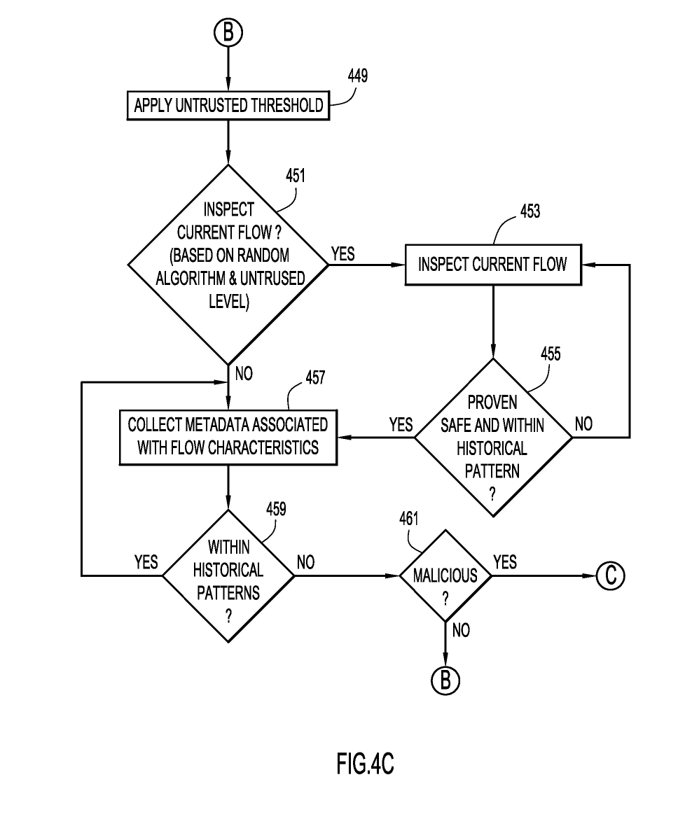

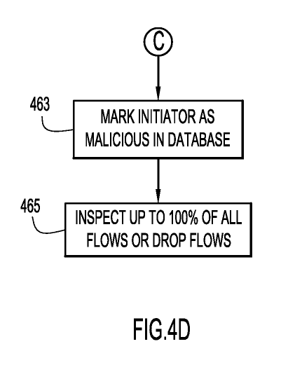

FIGS. 4A-4D show detailed example flow charts describing the techniques disclosed herein. The process described in FIGS. 4A-4D evaluates an incoming flow to categorize the incoming flow as trusted, untrusted or malicious. Inspection thresholds, for use in determining a proportion of traffic flows to be subject to in-depth inspection, may be configured by a device administrator. The inspection thresholds may be set independently for each initiator, each supported application, or each per-initiator application association. In some embodiments, TCP protocols may be used in conjunction with the techniques described herein, to indicate whether stateful inspection should be applied. In some instances, TCP-state-bypass-like behavior may be sufficient for a supported application.

Referring to FIG. 4A, for each new connection initiated through a security device comprising a selective flow inspector 120, the following tasks are generally performed after applying basic security checks through an Access Control List (ACL) or similar facility. At operation 405, an IP address of an initiator is determined. If the initiator (by virtue of a corresponding IP address) is determined to be new, as shown at operation 410, the corresponding traffic flow is automatically categorized as untrusted (by virtue of the initiator being unknown) and the process proceeds to operation 449 (in FIG. 4C) via ‘B’. If the IP address is not new, the process continues to operation 415, where the application from the initiator is identified, based on a protocol and destination port (or any other appropriate criteria). If the application is new, as determined at operation 420, the traffic flow is categorized as untrusted (by virtue of the application from a particular initiator being unknown), and the process proceeds to operation 449 via ‘B’. If the application is not new, then a corresponding historical usage data record for the initiator/application pair has been previously created, and this record is consulted at operation 425, to determine whether a record of malicious activity exists for the particular initiator/application association or initiator. If a record of prior malicious activity does not exist, the process proceeds to operation 430. Otherwise, if a record of malicious activity is present, the process proceeds to operation 463 (in FIG. 4D) via ‘C’.

At operation 430, the current usage data associated with the current session is compared with the historical usage data for the initiator/application combination, and if the current usage data falls within expected behavior (based upon the historical usage data), then the process continues to operation 435 (in FIG. 4B) via ‘A’. Otherwise, if the current flow pattern does not fall within expected behavior, then the process proceeds to operation 449 (in FIG. 4C) via ‘B’. It should be noted that a deviation from historical usage data does not automatically result in classification of a particular application/initiator combination as malicious, but rather, subjects the application to a higher threshold of deep-level inspection.

Referring to FIG. 4B, at operation 435, a trusted inspection level (or threshold) is applied to the traffic flow, which has previously been determined to fall within expected behavior based on historical usage data stored in a corresponding database record. Traffic flows from trusted application-initiator pairs are subject to a lower level of inspection as compared to untrusted traffic flows and traffic flows from initiators known to have previously exhibited malicious activity. At operation 437, a random algorithm based on statistical sampling is utilized to determine whether the current flow is to be selected for inspection. For example, if the inspection threshold for a trusted flow is set to be 1 out of every 10 flows, then 10% of traffic flows corresponding to a particular application-initiator pair will be subject to full inspection and the other 90% will not be inspected.

The random algorithm may be used to determine which traffic flow(s) of a group of traffic flow(s) are selected for inspection. As an example, for a first group of 10 traffic flows, the second traffic flow may be selected. For a second group of 10 traffic flows, the fifth traffic flow may be selected. For a third group of 10 traffic flows, no traffic flows may be selected, while for a fourth group of traffic flows, two traffic flows may be selected. Thus, over a period of time, 10% of all traffic flows are subject to inspection, with any given traffic flow having a 10% chance of being inspected.

For traffic flows that are not selected for inspection, packets of the corresponding traffic flows are matched against the existing connection entry (to bypass an ACL lookup) and transmitted after updating a total byte count in the corresponding database record without performing advanced security checking Flows that are not selected for inspection are subject to monitoring as described below, with regard to operations 443 and 445.

Referring back to FIG. 4B, at operation 439, the current flow, as determined by the random algorithm, is subjected to full inspection. At operation 441, if the inspection determines that the current usage data/patterns fall within normal historical usage data/patterns and that the flow is deemed to be safe, then the process proceeds to operation 443. If the inspected flow does not fall within expected historical usage data/patterns, then the flow may be subject to further inspection at operation 439. Over time, the flow may be identified as safe and may be exempt from further inspection. At that point, the flow is passively monitored to detect behavioral patterns deviating from historical usage data/patterns. Although not shown in FIG. 4B, flows that do not pass inspection at operation 441 may be subject to reclassification of their assigned threshold, as either untrusted or malicious.

At operation 443, current usage data is collected for the newly created stateful connection or the existing connection. For example, metadata associated with a length of duration, an exchanged byte count, etc., may be collected. The connection is monitored by comparing current usage data to historical usage data stored in the database record at operation 445. If the current usage data of the traffic flow exceeds stored historical data for the associated initiator/endpoint and application, the security device may enable full inspection of this flow by dynamically engaging, e.g., a TCP Normalizer, which may or may not be part of the IDS, to remove anomalies and inconsistencies in TCP traffic and/or the appropriate application inspection modules. The flow may also be inspected for malicious activity at operation 447, and be reclassified as either malicious or untrusted, pending the outcome of operation 447. The corresponding database record would also be updated to reflect reclassification of the corresponding reputation.

For traffic flows that are selected for inspection, such traffic flows undergo regular stateful checks up to the application level, if necessary. If any malicious activity is detected during a full inspection, the endpoint is flagged in the corresponding database record as exhibiting malicious activity, as shown in operation 447. Depending on configuration, if malicious activity is detected, the security device may immediately subject up to 100% of flows from a given endpoint/initiator to inspection or drop the connection completely.

Referring to FIG. 4C, if the initiator and/or application association is new or the current usage data does not conform to the stored historical usage data/pattern, the “untrusted” threshold will be applied. At operation 449, an untrusted inspection level is applied to the traffic flow. Traffic flows from initiators or application-initiator associations determined to be untrusted are subject to a higher level of inspection than as determined by trusted thresholds, but subject to lower levels of inspection than as determined by malicious levels of inspection, in which up to 100% of flows are generally subject to inspection (or dropped). At operation 451, a random algorithm based on statistical sampling is utilized to determine whether the current flow is to be selected for inspection. For example, if the inspection threshold for an untrusted flow is set to be 7 out of every 10 flows, 70% of traffic flows corresponding to a particular application-initiator association (or initiator) will be subject to full inspection and the other three flows will not be inspected. Similar to the previous discussion of FIG. 4B, for a first group of 10 traffic flows, any 7 of the 10 traffic flows may be inspected, with any given traffic flow having a 70% chance of being selected for inspection. For a second group of 10 traffic flows, the same reasoning applies, and so forth. This threshold provides better security than the trusted threshold, but is less computationally intense than the malicious threshold, which generally involves inspection up to 100% of traffic flows. For traffic flows that are not selected for inspection at operation 451, packets of the corresponding traffic flows are matched against the existing connection entry (to bypass an ACL lookup) and transmitted after updating the total byte count—without performing advanced security checking.

At operation 453, the current flow as determined by the random algorithm is subjected to full inspection. At operation 455, if the inspection determines that the current usage data/patterns fall within a normal historical pattern (it is noted that the historical pattern is constructed during this process) and that the flow is deemed to be safe, then the process proceeds to operation 457. In other words, the untrusted flow may eventually be deemed as safe, inspection may disengage/terminate, and behavioral monitoring may continue normally as part of operations 457 and 459. If the inspected flow does not pass inspection, then the flow may be subject to further inspection at operation 453. Although not shown in FIG. 4C, flows that pass inspection at operation 455 may be subject to reclassification of their assigned threshold as trusted.

At operation 457, current usage data is collected for the newly created stateful connection or existing connection. For example, metadata associated with an expected duration, byte count, etc., may be collected. At operation 459, current usage data may be compared to historical usage data stored in the database record. If the flow exhibits current usage data/patterns deviating from expected behavior, based on historical usage data, the flow may be subject to additional inspection. If the current usage data exceeds stored historical usage data for the endpoint/initiator and associated application, the security device may enable full inspection of this flow by dynamically engaging the TCP Normalizer and/or the appropriate application inspection modules. At operation 461, the flow may be inspected for malicious activity, and be reclassified as malicious or continue to be classified as untrusted, pending the outcome of operation 461. The corresponding database record would also be updated to reflect reclassification, e.g., such as flagging malicious activity.

For traffic flows that are selected for inspection, such traffic flows undergo regular stateful checks up to the application level, if necessary, as long as the connection is maintained. If any malicious activity is detected during a full inspection, the endpoint/initiator is flagged in the corresponding database record as exhibiting malicious activity, as shown in operation 461, and as described below in connection with FIG. 4D.

As the reputation of each monitored initiator-application combination builds over time, the threshold for sampling will be adjusted accordingly. For example, an endpoint which repeatedly establishes a “clean” Simple Mail Transfer Protocol (SMTP) connection may be chosen for Extended Simple Mail Transfer Protocol (ESMTP) application inspection for inspection based upon a trusted threshold. Another initiator/endpoint mostly initiating HTTP sessions may be selected by an ESMTP inspection engine according to an untrusted threshold while its historical usage profile is built.

Referring to FIG. 4D, this inspection level is associated with malicious activity and is generally set to inspect up to 100% of traffic flows. At operation 463, all traffic from an endpoint which previously committed a security policy violation during selective inspection is marked as malicious in its corresponding database record. At operation 465, a larger percentage of flows, up to 100% of traffic flows, from the corresponding initiator-application pair may be subject to full inspection (unless reset by an administrator) or the administrator may configure the security device to drop all such traffic rather than inspect it. In some embodiments, all traffic from a particular initiator may be marked as malicious (and not just an application-inspection pair). In other aspects, if an inspection engine detects malicious activity from a particular endpoint/initiator, the security device may generate an alert and send to an administrator regarding such activity.

Referring to FIG. 5, source IP address 510 indicates the source IP address of an initiator of a traffic flow. Incoming traffic flows may be matched to known initiators (stored in a database) based on source IP address 510, and if a corresponding entry is not found in a database, new initiators are automatically added as untrusted.

Based upon previous inspection(s), a reputation 520 is generated and associated with each initiator. A reputation may be flagged as ‘malicious’, if the initiator has been associated with previous malicious activity. In general, once reputation profiles for frequent initiators are built, such profiles change incrementally as a function of time.

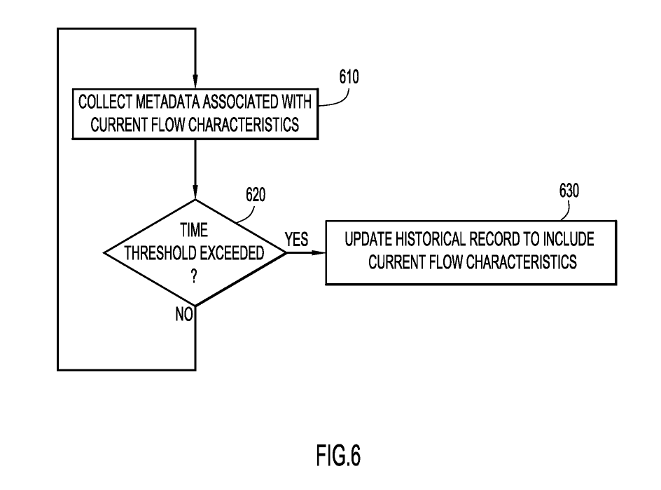

Each initiator in the database is associated with a snapshot of current application usage data (for current usage) and a historical usage data (for past usage). As an example, for an initiator associated with source IP address 192.168.1.100, current usage data 530 and corresponding historical usage data 540 are shown. It should be noted that the current usage data is incorporated into historical usage data at a prescribed periodic interval of time, as disclosed herein and with reference to FIG. 6.

Current usage data 530 indicates various collected data from a current session, and includes application information, based on destination port and protocol, for each type of application associated with a particular initiator. Current usage data 530 shows, for example, various types of applications that have been associated with this initiator, based upon application protocol/port 532(1), as well as connection count 532(2), total data 532(3), total packets 532(4) and length of duration 532(5) for each application. Connection count 532(2) represents the number of times that an initiator has attempted to establish and/or complete a connection, that is, gain access to the LAN through security device 130. In some embodiments, the connection count may be cumulative over a monitored period of time for a given initiator and stored under a given application association. For example, an HTTP application (as identified based on protocol TCP/port 80) may have a connection count 532(2) of 350 for a monitored period of current activity. Total data 532(3) and total packets 534(4) are directed towards the amount of bytes or number of packets exchanged from an initiator during a prescribed period of time. Length of duration 532(5) is directed towards one or more connection times. In some embodiments, connection count 532(2), length of duration 532(5), total exchanged data 532(3) and total packet count 532(4) are stored as cumulative values over a prescribed period of time, and are added to values previously stored in current data 530 under the particular application type for a particular endpoint/initiator. Thus, an average length of duration and an average data transfer per connection can be established using this information.

The present embodiments are not intended to the limited by the particular types of information stored in current usage data 530 and historical usage data 540. Additional types of information may be stored and used for comparison purposes as well.

Historical usage data 540 generally contains the same types of information as current usage data 530, but for an earlier period in time. Every new connection (under current usage data 530) is compared to the historical usage data to see if it “conforms” to an expected usage pattern. Connections that deviate from or exceed expected usage patterns may be flagged, inspected, and subsequently reclassified as untrusted or malicious. For example, FIG. 5 shows an example of behavior that exceeds historical usage data. HTTP connection associated with source IP address 192.168.1.100 has a length of duration 532(5) and total data 532(3) that significantly exceeds the historical usage data, e.g., current usage data for these categories is more than 10 times greater than historical usage data. Thus, this initiator application association would be flagged for further inspection, and the reputation of the initiator possibly reclassified as malicious or untrusted pending the outcome of the inspection.

Referring now to FIG. 6, at a periodic interval, a snapshot of the current usage data/patterns for each initiator will be rotated into the historical record, so the security device will have a comparison baseline that is adaptive to usage characteristics over time. At operation 610, data is collected that is associated with current usage activities (current usage data). At operation 620, it is determined whether the time threshold has been exceeded. At operation 630, the historical usage data is updated to include the current usage data. As such, each initiator record will have one current and one historical usage data/pattern at any given point in time. Thus, in some embodiments, historical usage data may comprise usage data associated with usage characteristics collected at multiple instants of time. As previously discussed, the comparison between the current and historical usage patterns will establish the level of inspection the security device will apply to subsequent connections from the respective initiator.

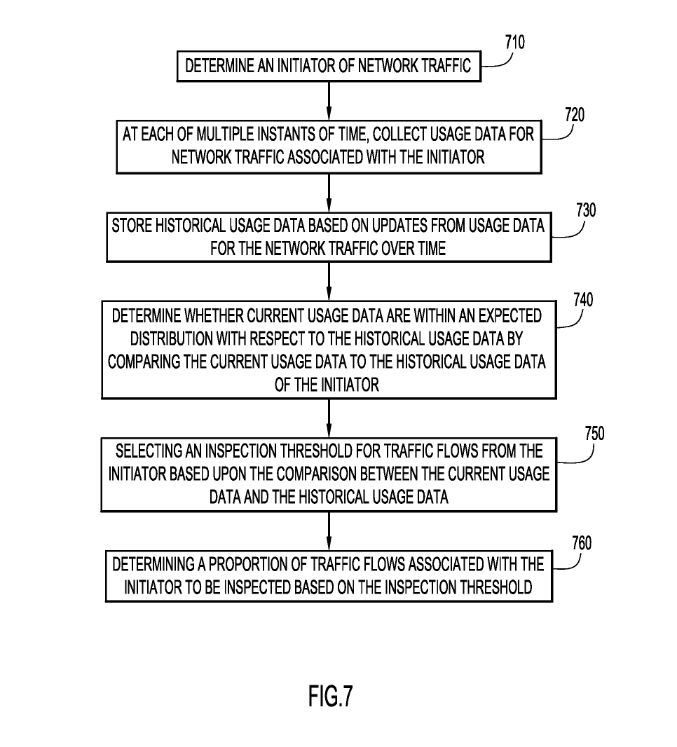

FIG. 7 shows a high-level/generalized flowchart of operations performed by selective flow inspector 120 according to the techniques described herein. At operation 710, an initiator of network traffic is determined. At operation 720, at each of multiple instants of time, usage data for network traffic associated with the initiator is collected. At operation 730, historical usage data based on updates from usage data for the network traffic over time is stored. At operation 740, a determination is made as to whether current usage data are within an expected distribution with respect to the historical usage data by comparing the current usage data to the historical usage data of the initiator. At operation 750, an inspection threshold is selected for traffic flows from the initiator based upon the comparison between the current usage data and the historical usage data. At operation 760, a proportion of traffic flows associated with the initiator to be inspected is determined based on the inspection threshold.

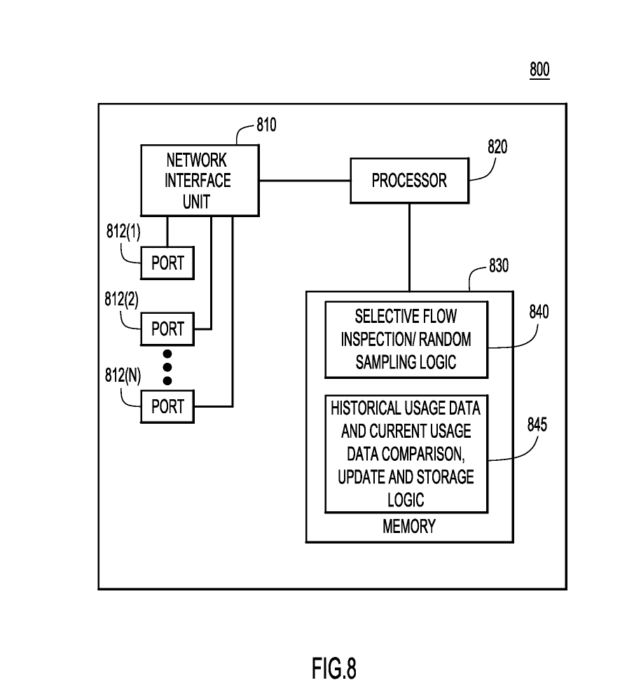

FIG. 8 illustrates an example block diagram of an apparatus, security device 130 and selective flow inspector 120, configured to perform the techniques presented herein. The apparatus includes a network interface unit 810, a processor 820, and a memory 830. The network interface unit 810 is configured to enable network communications over a network to send or receive traffic flows between e.g., local area networks and wide area networks.

The processor 820 may be embodied by one or more microprocessors or microcontrollers, and executes software instructions stored in memory 830 for selective flow inspection/random sampling logic 840, historical usage data and current usage data comparison, update and storage logic 845, to perform the operations described above in connection with FIGS. 1-7. For purposes of simplicity, aspects of the security device 130, specific to the type of security device (e.g., firewalls, IPSs, etc.) are not shown.

Memory 830 may be embodied by one or more computer readable storage media that may comprise read only memory (ROM), random access memory (RAM), magnetic disk storage media devices, optical storage media devices, flash memory devices, electrical, optical, or other physical/tangible memory storage devices.

Thus, in general, the memory 830 may comprise one or more tangible (e.g., non-transitory) computer readable storage media (e.g., a memory device) encoded with software comprising computer executable instructions, and when the software is executed by the processor 820, the processor 820 is operable to perform the operations described herein in connection with selective flow inspection/random sampling logic 840 and historical usage data and current usage data comparison, update, and storage logic 845.

The functions of the processor 820 may be implemented by logic encoded in one or more tangible computer readable storage media or devices (e.g., storage devices compact discs, digital video discs, flash memory drives, etc. and embedded logic such as an ASIC, digital signal processor instructions, software that is executed by a processor, etc.).

While FIG. 8 shows that the apparatus may be embodied as a dedicated physical device, it should be understood that the functions of the apparatus 800 may be embodied as software running in a data center/cloud computing system, together with numerous other software applications.

It should be noted that the above techniques may not be effective when used with certain protocols where the security device performs Network Address Translation (NAT) or opens ACL pinholes to permit secondary channels based on application payload. While such connections must undergo full application inspection, the described method can still be used on other transit traffic which typically comprises a vast majority of the firewall load.

The techniques associated with selective flow inspection, as disclosed herein, allow maintaining a high level of security while processing a much higher volume of traffic than comparable security devices without selective flow inspection, which inspect all transit connections (that are not exempted from inspection). Thus, the techniques disclosed herein reduce computational load, while providing a deterrent by using smart inspection policies to screen for malicious activity.

Unlike a purely random check, which discounts good behavior and distributes processing resources to all traffic equally, the techniques disclosed herein distribute resources to flows that are unknown or deemed to be from a malicious source. The proposed model relies on historical usage data, established reputation (e.g., whether or not a flow originates from a malicious initiator), and ongoing monitoring of traffic flows to direct processing resources specifically to the unknown or suspect connections. Moreover, even if a previously trusted host suddenly attempts malicious activities, periodic mandatory checks on trusted initiators will detect this behavior and adjust the associated inspection threshold accordingly.

The methods disclosed herein are generally relevant in scenarios where 100% of traffic inspection is not required. Over a period of time, selective inspection will detect traffic that is malicious or behaving differently than expected. For instance, a perimeter IPS device in front of a Demilitarized Zone (DMZ) and a hardened interior firewall will still inspect a sufficient amount of inbound traffic to block most attackers and relieve the interior protection devices from the additional load (a “defense in depth” approach). As another example, the techniques disclosed herein may help enforce a corporate security policy. For instance, by inspecting a portion of outbound HTTP(S) traffic flows from a user within a local area network, a user engaging in activities that are not permitted by a corporate security policy (e.g., gaming sites, sites considered to unsafe or illegal, etc.) will eventually be blocked with a warning page, an e-mail, and/or an administrative notification. Selective monitoring provides a deterrent to engaging in unauthorized activity.

Additionally, the techniques disclosed herein are particularly useful for: (a) adding a transparent perimeter security device for initial filtering of ingress traffic, (b) offering a sufficient level of protection for a site having a heavily overloaded security device that cannot be immediately upgraded, (c) inspecting transit traffic at a low sampling rate and achieving a minimal impact on associated performance—the sampling rate may be later increased if desired, and (d) offering, e.g., by managed services providers, different tiers of selective protection at different price points. As with all of the above scenarios, trusted applications and endpoints will be passed through the security device with minimal delay.

In summary, unknown connections from an endpoint/initiator will undergo a higher level of inspection, and periodic checks of trusted traffic will detect abnormal behavior. Once a threat is detected, all subsequent traffic from the endpoint/initiator will be subject to additional inspection to prevent subsequent attacks, and administrative activity may be invoked to block traffic flows from the initiator/endpoint. While a small number of traffic flows exhibiting abnormal behavior may initially not be detected (as a subset of trusted and unknown traffic flow are subject to inspection), the threat will eventually be detected.

Overall cost savings from not statefully inspecting every flow will result in a significant overall performance gain. Additionally, because the depth of inspection may be adjusted (e.g., by applying only TCP stateful inspection as opposed to adding IPS services), the difference between inspecting all flows and a subset of flows provides a significant benefit in terms of performance and computational workload. The techniques disclosed herein provide comprehensive and flexible monitoring, which may be adjusted based on user preference.

The techniques presented herein may apply to any resources that are commonly shared, and are not limited to the specific examples disclosed herein.

The techniques presented herein provide a computer-implemented method, apparatus and computer readable media (storing processor-executable instructions) for determining an initiator of network traffic, collecting at each of multiple instants of time, usage data for network traffic associated with the initiator, and storing historical usage data based on updates from usage data for the network traffic over time. Current usage data are compared to historical usage data of the initiator to determine whether current usage data are within an expected distribution with respect to the historical usage data. Based upon the comparison between the current usage data and the historical usage data, an inspection threshold is selected for traffic flows from the initiator, and a proportion of traffic flows associated with the initiator is determined to be inspected based on the inspection threshold.

Although the apparatus, system, and computer-implemented method are illustrated and described herein as embodied in one or more specific examples, it is nevertheless not intended to be limited to the details shown, since various modifications and structural changes may be made therein without departing from the scope of the apparatus, system, and computer-implemented method and within the scope and range of equivalents of the claims. Accordingly, it is appropriate that the appended claims be construed broadly and in a manner consistent with the scope of the apparatus, system, and computer-implemented method, as set forth in the following claims.

In summary, according to one aspect, a method is provided comprising a computer-implemented method comprising: determining an initiator of network traffic; at each of multiple instants of time, collecting usage data for network traffic associated with the initiator; storing historical usage data based on updates from usage data for the network traffic over time; determining whether current usage data are within an expected distribution with respect to the historical usage data by comparing the current usage data to the historical usage data of the initiator; selecting an inspection threshold for traffic flows from the initiator based upon the comparison between the current usage data and the historical usage data; and determining a proportion of traffic flows associated with the initiator to be inspected based on the inspection threshold.

An apparatus is provided comprising: a network interface unit configured to receive communications over a network; memory configured to store usage data and historical usage data; and one or more processors coupled to the network interface unit, and configured to: determine an initiator of network traffic; at each of multiple instants of time, collect usage data for network traffic associated with the initiator; store historical usage data based on updates from usage data for the network traffic over time; determine whether current usage data are within an expected distribution with respect to the historical usage data by comparing the current usage data to the historical usage data of the initiator; select an inspection threshold for traffic flows from the initiator based upon the comparison between the current usage data and the historical usage data; and determine a proportion of traffic flows associated with the initiator to be inspected based on the inspection threshold.

Similarly, according to another aspect, a computer-implemented method is provided comprising: storing in a database, current usage data for an initiator of network traffic, wherein the stored usage data is descriptive of an application type for each network traffic flow associated with the initiator and is cumulative over a prescribed period of time determining whether the current usage data are within an expected distribution with respect to historical usage data by comparing the current usage data to the historical usage data; selecting an inspection threshold for traffic flows from the initiator based upon the comparison between the current usage data and the historical usage data; and determining a proportion of traffic flows associated with the initiator to be inspected based on the inspection threshold.

The above description is intended by way of example only. Various modifications and structural changes may be made therein without departing from the scope of the concepts described herein and within the scope and range of equivalents of the claims.

What is claimed is:

1. A computer-implemented method comprising:
determining an initiator of network traffic;
at each of multiple instants of time, collecting usage data for network traffic associated with the initiator;
storing historical usage data based on updates from usage data for the network traffic over time;
determining whether current usage data are within an expected distribution with respect to the historical usage data by comparing the current usage data to the historical usage data of the initiator;
selecting an inspection threshold for traffic flows from the initiator based upon the comparison between the current usage data and the historical usage data; and
determining a proportion of traffic flows associated with the initiator to be inspected based on the inspection threshold.

2. The method of claim 1, wherein collecting usage data comprises collecting data descriptive of an application type for each network traffic flow associated with the initiator.

3. The method of claim 1, further comprising:
determining whether a current traffic flow from the initiator is to be inspected based upon a random algorithm that selects traffic flows for inspection in accordance with the selected inspection threshold; and
inspecting the current traffic flow as determined by the random algorithm and the historical usage data of the initiator and an application.

4. The method of claim 1, further comprising:
repeatedly monitoring current usage data to determine whether the current usage data are within the expected distribution; and
in response to determining that the current usage data deviates from the expected distribution, selecting another inspection threshold resulting in inspection of a higher proportion of traffic flows as compared to the proportion of traffic flows currently inspected.

5. The method of claim 1, wherein determining comprises determining whether the current usage data are within an expected distribution based on the historical usage data by comparing one or more of traffic flow duration, port type, exchanged byte count, exchanged packet count and total data usage.

6. The method of claim 1, further comprising:
determining that historical usage data for the initiator is unknown; and
if it is determined that the historical usage data is unknown, selecting an inspection threshold that results in inspection of a greater proportion of traffic flows from the initiator as compared to a proportion of traffic flows currently selected for inspection.

7. The method of claim 6, further comprising:
establishing a trusted reputation for the initiator based upon inspecting the traffic flows from the initiator; and
selecting another inspection threshold resulting in inspection of a lesser proportion of traffic flows from the initiator as compared to a proportion of traffic flows currently selected for inspection if a trusted reputation for the initiator is established.

8. The method of claim 1, further comprising:
determining whether the initiator has previously been associated with malicious network activity; and
inspecting or dropping all traffic flows from the initiator when it is determined that the initiator has previously been associated with malicious network activity.

9. An apparatus comprising:
a network interface unit configured to receive communications over a network;
memory configured to store usage data and historical usage data; and
one or more processors coupled to the network interface unit, and configured to:
determine an initiator of network traffic;
at each of multiple instants of time, collect usage data for network traffic associated with the initiator;
store historical usage data based on updates from usage data for the network traffic over time;
determine whether current usage data are within an expected distribution with respect to the historical usage data by comparing the current usage data to the historical usage data of the initiator;
select an inspection threshold for traffic flows from the initiator based upon the comparison between the current usage data and the historical usage data; and
determine a proportion of traffic flows associated with the initiator to be inspected based on the inspection threshold.

10. The apparatus of claim 9, wherein the processor is further configured to collect data descriptive of an application type for each network traffic flow associated with the initiator.

11. The apparatus of claim 9, wherein the processor is further configured to:
determine whether a current traffic flow from the initiator is to be inspected based upon a random algorithm that selects traffic flows for inspection in accordance with the selected inspection threshold; and
inspect the current traffic flow as determined by the random algorithm and the historical usage data of the initiator and an application.

12. The apparatus of claim 9, wherein the processor is further configured to:
repeatedly monitor current usage data to determine whether the current usage data are within the expected distribution; and
select another inspection threshold resulting in inspection of a higher proportion of traffic flows as compared to the proportion of traffic flows currently inspected, in response to determining that the current usage data deviates from the expected distribution.

13. The apparatus of claim 9, wherein the processor is further configured to:
determine whether the current usage data are within an expected distribution based on the historical usage data by comparing one or more of traffic flow duration, port type, exchanged byte count, exchanged packet count and total data usage.

14. The apparatus of claim 9, wherein the processor is further configured to:
determine that historical usage data for the initiator is unknown; and
select an inspection threshold that results in inspection of a greater proportion of traffic flows from the initiator as compared to a proportion of traffic flows currently selected for inspection, if it is determined that the historical usage data is unknown.

15. The apparatus of claim 14, wherein the processor is further configured to:
establish a trusted reputation for the initiator based upon inspecting the traffic flows from the initiator; and
select another inspection threshold resulting in inspection of a lesser proportion of traffic flows from the initiator as compared to a proportion of traffic flows currently selected for inspection, if a trusted reputation for the initiator is established.

16. The apparatus of claim 9, wherein the processor is further configured to:
determine whether the initiator has previously been associated with malicious network activity; and
inspect or drop all traffic flows from the initiator when it is determined that the initiator has previously been associated with malicious network activity.

17. A computer-implemented method comprising:
storing in a database, current usage data for an initiator of network traffic, wherein the stored usage data is descriptive of an application type for each network traffic flow associated with the initiator and is cumulative over a prescribed period of time;
determining whether the current usage data are within an expected distribution with respect to historical usage data by comparing the current usage data to the historical usage data;
selecting an inspection threshold for traffic flows from the initiator based upon the comparison between the current usage data and the historical usage data; and
determining a proportion of traffic flows associated with the initiator to be inspected based on the inspection threshold.

18. The method of claim 17, wherein the stored cumulative data comprises information pertaining to the number of times that an initiator has attempted and/or completed a connection with a security device, the total amount of data or packets transferred, and/or the length of time of the connection.

19. The method of claim 18, wherein determining whether the current usage data are within an expected distribution with respect to the historical usage data further comprises:
determining an average amount of data or packets transferred per connection and an average length of duration per connection; and
comparing one or more of the determined average values of current usage data to corresponding average values of the historical usage data to determine if the current usage data significantly deviates from the historical usage data.

20. The method of claim 17, further comprising repeatedly monitoring current usage data to determine whether the current usage data are within the expected distribution; and in response to determining that the current usage data deviates from the expected distribution, selecting another inspection threshold resulting in inspection of a higher proportion of traffic flows as compared to the proportion of traffic flows currently inspected.
